(19) United States
(12) Patent Application Publication
(10) Pub. No.: US 2023/0314272 A1
(43) Pub. Date: Oct. 5, 2023

(54) METHOD FOR REAL-TIME IDENTIFICATION, MONITORING, AND EARLY WARNING OF VORTEX-INDUCED VIBRATION EVENT OF LONG-SPAN SUSPENSION BRIDGE

(71) Applicant: TONGJI UNIVERSITY, Shanghai (CN)

(72) Inventors: Danhui DAN, Shanghai (CN); Houjin LI, Shanghai (CN)

(21) Appl. No.: 18/020,453

(22) PCT Filed: Nov. 22, 2021
(86) PCT No.: PCT/CN2021/132169

§ 371 Date: Feb. 9, 2023

(30) Foreign Application Priority Data
Nov. 24, 2020 (CN) 202011331924.1

(51) Int. Cl. G01M 5/00; G01L 5/04

(52) U.S. Cl. CPC G01M 5/0066; G01M 5/0008; G01L 5/042; G06F 17/142

(57) ABSTRACT

The invention discloses a real-time online monitoring, perception, and early warning method for vortex-induced vibration of suspension bridges. Based on the fast Fourier transform FFT of the bridge acceleration monitoring signal, The first-order nature frequency of the bridge can be obtained by reading the horizontal coordinate corresponding to the first-order energy peak of the spectrum and determine the high-pass filter cut-off frequency. The low-frequency noise is eliminated by the filter in order to calculate the displacement of the bridge by the recursive acceleration integration method; Taking the integrated displacement data as the real part and its Hilbert transform as the imaginary part, the analytic signal is plotted and evaluated in the complex plane to achieve the perception and early warning of VIVs. The advantages of the invention are real-time, high precision, accuracy and intuition, online real-time VIV perception and measurement of bridge vibration parameters during VIV can be realized.

### TECHNICAL FIELD OF THE INVENTION

This invention relates to the field of structural health monitoring of long span bridges, and in particular to a real-time monitoring, perception and early warning method for VIVs of suspension bridge.

### BACKGROUND OF THE INVENTION

Vortex-induced vibration (VIV) is a serious problem in long-span bridges during their service periods, which is one kind of self-limiting vibration result primarily from periodic vortex separation when air flows through the bluff body section. Although VIV is not like flutter, galloping and other dispersive vibrations that can lead to dynamic instability or collapse of bridges, but VIV is easy to occur in a low wind speed range, and the larger amplitude will cause serious fatigue problems with respect to key components of the engineering structure, VIV also affect directly driving comfort and safety. Therefore, if real-time online monitoring, perception, and early warning of bridge VIV events can be realized, it will provide direct support for traffic management decision making and in-time vibration control.

Recent research on bridge VIV mechanisms is relatively mature, but these works are mostly based on monitoring data acquired during the VIV period, and statistically analyzed by batch processing after the event. However, a large number of studies on semi-active control of VIV are premised on the identification of VIV generation online and in real-time. Therefore, there is an urgent need for a real-time identification method for the occurrence of bridge VIV events in an online monitoring environment.

There is a clear difference between VIV and normal vibration of bridges, VIV approximates a single-mode vibration, its Fourier spectrum presents a single energy peak, the rest of the peak energy is very small, and the bridge vibration response is sinusoidal-like during VIV. Based on these characteristics of VIV, the current bridge VIV identification is mainly to identify the stable sinusoidal vibration segments in the bridge monitoring data by human eyes, or by performing spectrum analysis on a segment of data and manually determining whether there is only a single spectrum peak. The disadvantages of these two methods are that the manual visual judgment is inaccurate, easy to misjudge or miss judgment; batch spectrum analysis method cannot perform online real-time judgment. Moreover, the above two methods are unable to accurately sense the occurrence and end moment of VIV, these are where this invention needs to focus on improvement.

### SUMMARY OF THE INVENTION

The technical problem to be solved by this invention is to provide a real-time online monitoring, perception, and early warning method for VIVs of suspension bridges based on the recursive Hilbert transform.

In order to solve the above technical problems, the present invention provides a new solution comprising the following steps:
Step 1: Based on the bridge acceleration monitoring signal, The first-order nature frequency fₛ of the bridge can be obtained by reading the horizontal coordinate corresponding to the first-order energy peak of the spectrum through the fast Fourier transform FFT and determine the filter cut-off frequency f_{c}:

f_{c}=αfₛ;
where α is the filtering proportion coefficient, which can be set in the range of ¼-⅓ for long-span bridges
Step 2: the high-pass filter is used to eliminate the low-frequency noise of original acceleration signal, the following recursive high-pass filter is selected:

$${y}_{i} = \frac{1 + q}{2} ( {x}_{j} - {x}_{j - 1} ) + {qy}_{j - 1} ;$$

where xⱼ and yⱼ (j=1, 2, 3 . . . ) are the input and output signals, respectively, q is a constant parameter approximating to 1;
Step 3: Calculate the displacement of the bridge by the recursive acceleration integration method:

The recursive least-square method is first used for baseline correction, a recursive high-pass filter is used to filter the low-frequency noise in the monitoring acceleration signal, and the acceleration is then integrated to obtain the bridge displacement.
Step 4: Taking the displacement data obtained by integration as the real part and its Hilbert transform as the imaginary part, the analytic signal is given as:

X(t)=x(t)+i\hat{x}(t);
Where \hat{x}(t) is the Hilbert transform of the time-domain signal x(t): \hat{x}(t)=H(x(t)) and i is the imaginary unit.

For discrete monitoring data, the form of Hilbert transform can be expressed as:

$$\hat{x} ( t ) = {\sum }_{m = 0}^{N} h ( i - m ) x ( m )$$

Where x(m) is the sampling signal;
N is the length of the sampling signal, h(i) is the discrete Hilbert transform impulse response operator, which has the closed form:

$$h ( i ) = \frac{2}{N} {sin}^{2} ( π i / 2 ) cot ( π i / N ) ;$$

The real and imaginary parts of the analytical signal in the complex domain can be calculated, and the image of the data complex plane vector is drawn with the real part as the x-axis and the imaginary part as the y-axis.

Or by directly applying the short-time recursive Hilbert transform to the real-time acceleration monitoring signal and plotting the complex plane vector image with the real part as the x-axis and the imaginary part as the y-axis.
Step 5: VIV judgement:
1) Vector images generated by the real and imaginary parts of the complex domain analytical signal.

If VIV occurs, the image shows circular characteristics; the image in the non-VIV region is cluttered and irregular, the image features can help achieve the real-time identification and early warning of VIV generation.
2) Vector images generated by the real and imaginary parts of the original acceleration signal.

If VIV occurs, the image shows approximately circular features; the image in the non-VIV region is cluttered and irregular, the image features can help achieve the real-time identification and early warning of VIV generation.

Based on the integral displacement signal of Step 3, the instantaneous phase, frequency, and vibration amplitude of bridge during VIVs can be further calculated:
1) The instantaneous phase:

The real part and imaginary part of the integral displacement signal, then the instantaneous phase Φ(t) of VIV is given by:

$${φ}_{t} = arc tg \frac{\hat{x} ( t )}{x ( t )} ;$$

2) The instantaneous frequency:

The instantaneous frequency fₜ is calculated by calculating the first derivative of instantaneous phase with respect to time:

$${f}_{t} = \frac{d {φ}_{t}}{dt} = \frac{d}{dt} arc tg \frac{\hat{x} ( t )}{x ( t )} ;$$

3) The real-time amplitude:

The real-time amplitude Aₜ of bridge during VIV can be obtained by calculating the modulus of the real and imaginary parts of the analytic signal in the complex field:

Aₜ=\sqrt{x(t)²+\hat{x}(t)²};

Based on the sinusoidal-like vibration characteristics of the bridge during VIV, the invention create a recursive Hilbert transform to convert the one-dimensional monitoring signal in the time domain into a two-dimensional complex plane vector, which presents a standard circular shape when VIV occurs, and clearly and intuitively identifies the occurrence of bridge VIV.

The superior efficacy of the present invention is that:
1) The invention is based on recursive processing of monitoring acceleration data and short-time recursive Hilbert transformation, which can display the vibration state of the bridge in real time. Moreover, the display results under random vibration and VIV of the bridge have obvious differences, which can intuitively and accurately perceive the occurrence of bridge VIV, serve for the vibration control and the maintenance of the bridge. This method meets the requirements of real-time and continuity under online monitoring environment, easy to implementation, with high engineering application value and broad application prospects.
2) The operation process of the invention is simple, and the analysis results through real-time monitoring data processing show that it is extremely easy to identify and perceive the generation of VIV of bridge. In addition, the real-time warning and online measurement of VIV can be realized by calculating the instantaneous index of VIV, and the calculation is efficient and can operate continuously and stably.
3) The invention is characterized by high real-time (second level), high precision, accuracy and intuition.
4) The invention can be used for online real-time perception of the beginning and end moments of bridge VIV as well as identifying and measuring the vibration characteristics of the bridge during VIV, such as instantaneous frequency, phase, amplitude, etc., and accordingly for early warning and online monitoring of bridge VIV.
5) The invention has a wide range of application scenarios.

### BRIEF DESCRIPTION OF THE FIGURES

The accompanying drawing illustrates an embodiment of the present invention.

FIG. 1 shows a flow chart and data processing scheme of the invention.

FIG. 2a shows the trajectories of analytical signal obtained by recursive Hilbert transform processing of the original acceleration data in VIV period;

FIG. 2b shows the trajectories of analytical signal obtained by recursive Hilbert transform processing of the integral displacement data in VIV period;

FIG. 3a shows the trajectories of analytical signal obtained by recursive Hilbert transform processing of the original acceleration data in non-VIV period;

FIG. 3b shows the trajectories of analytical signal obtained by recursive Hilbert transform processing of the integral displacement data in non-VIV period;

### DESCRIPTION OF SOME EMBODIMENTS OF THE INVENTION

The following is a detailed description of the invention with the accompanying drawings.

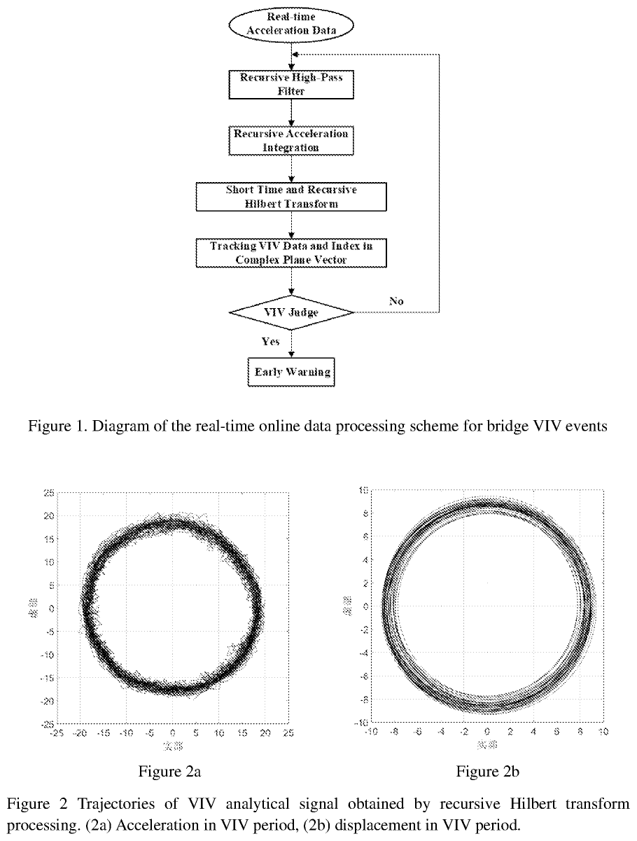

FIG. 1 illustrates a flow chart and the data processing scheme of the invention. As shown in FIG. 1, the present invention provides a new solution for the real-time online monitoring, perception, and early warning of VIVs of suspension bridges. For example, a segment of real-time acceleration monitoring data of the real bridge health monitoring system is used for calculation and analysis, with a sampling frequency of 50 Hz, and then the following steps are performed:
Step 1: Based on the bridge monitoring acceleration signal, the first-order nature frequency fₛ of the bridge can be obtained by reading the horizontal coordinate corresponding to the first-order energy peak of the spectrum through the fast Fourier transform FFT and determine the filter cut-off frequency f_{c}:

f_{c}=αfₛ;
Where α is the filtering proportion coefficient, which can be set in the range of ¼-⅓ for long-span bridges.
Step 2: the high-pass filter is used to eliminate the low-frequency noise of original acceleration signal, the following recursive high-pass filter is selected:

$${y}_{i} = \frac{1 + q}{2} ( {x}_{j} - {x}_{j - 1} ) + {qy}_{j - 1} ;$$

Where xⱼ and yⱼ(j=1, 2, 3 . . . ) are the input and output signals, respectively, q is a constant parameter approximating to 1.
Step 3: Calculate the displacement of the bridge by the recursive acceleration integration method:

The recursive least-square method is first used for baseline correction, a recursive high-pass filter is used to filter the low-frequency noise in the monitoring acceleration signal, and the acceleration is then integrated to obtain the bridge displacement.
Step 4: Taking the displacement data obtained by integration as the real part and its Hilbert transform as the imaginary part, the analytic signal is given as:

x(t)=x+i\hat{x}(t);
Where \hat{x}(t) is the Hilbert transform of the time-domain signal x(t): \hat{x}(t)=H(x(t)) and i is the imaginary unit.

For discrete monitoring data, the form of Hilbert transform can be expressed as:

$$\hat{x} ( t ) = {\sum }_{m = 0}^{N} h ( i - m ) x ( m )$$

Where x(m) is the sampling signal;
N is the length of the sampling signal, h(i) is the discrete Hilbert transform impulse response operator, which has the closed form:

$$h ( i ) = \frac{2}{N} {sin}^{2} ( π i / 2 ) cot ( π i / N ) ;$$

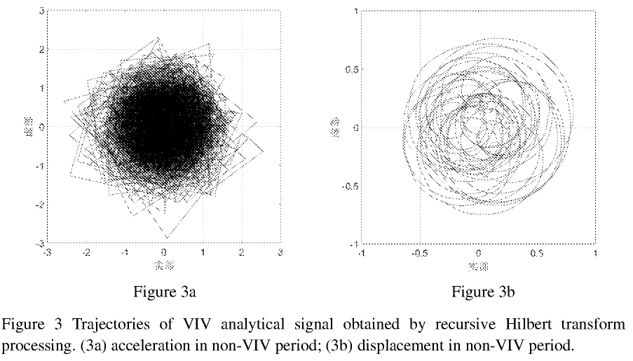

The real and imaginary parts of the analytical signal in the complex domain can be calculated, and the image of the data complex plane vector is drawn with the real part as the x-axis and the imaginary part as the y-axis. If VIV occurs, the image shows circular characteristics as shown in FIG. 2b; the image in the non-VIV region is cluttered and irregular as shown in FIG. 3b, the image features can help achieve the real-time identification and early warning of VIV generation.

Or by directly applying the short-time recursive Hilbert transform to the real-time acceleration monitoring signal and plotting the complex plane vector image with the real part as the x-axis and the imaginary part as the y-axis. If VIV occurs, the image shows approximately circular features as shown in FIG. 2a; the image in the non-VIV region is cluttered and irregular as shown in FIG. 3a; the image features can help achieve the real-time identification and early warning of VIV generation.

The invention also provides a method for real-time tracking and measurement of VIV events of long span suspension bridges, comprising the steps of:
1) Calculate the real-time bridge vibration displacement:

The recursive least-square method is first used for baseline correction, a recursive high-pass filter is used to filter the low-frequency noise in the monitoring acceleration signal, and the acceleration is then integrated to obtain the bridge displacement.
2) The instantaneous phase:

The real part and imaginary part of the integral displacement signal, then the instantaneous phase φₜ of VIV is given by:

$${φ}_{t} = arc tg \frac{\hat{x} ( t )}{x ( t )} ;$$

3) The instantaneous frequency:

The instantaneous frequency fₜ be calculated by calculating the first derivative of instantaneous phase with respect to time:

$${f}_{t} = \frac{d {φ}_{t}}{dt} = \frac{d}{dt} arc tg \frac{\hat{x} ( t )}{x ( t )} ;$$

4) The real-time amplitude:

The real-time amplitude Aₜ of bridge during VIV can be obtained by calculating the modulus of the real and imaginary parts of the analytic signal in the complex field:

Aₜ=\sqrt{x(t)²+\hat{x}(t)²};

The real-time full process measurement of VIV can be realized.

The invention can be used for monitoring, perception, and early warning of VIV for the main girders, tension cables, main cables and suspension cables of large-span suspension bridges or cable-stayed bridges, for the decision making and management of bridge owners; it can also be used in other engineering structures with cross-wind VIV monitoring needs, such as cables, towers, high-rise buildings, and model experiments in wind tunnel laboratories.

The above description is only a preferred embodiment of the invention, and is not intended to limit the use of this invention, which may be subject to various modifications and variations in the field. Any modification, equivalent replacement, improvement, etc. made within the spirit and principles of the present invention shall be included in the scope of protection of the present invention.

1. A method for real-time online monitoring, perception, and early warning of VIVs of suspension bridges comprising the following steps:
Step 1: Based on the bridge monitoring acceleration signal, the first-order nature frequency fₛ of the bridge can be obtained by reading the horizontal coordinate corresponding to the first-order energy peak of the spectrum through the fast Fourier transform FFT and determine the filter cut-off frequency f_{c}:
f_{c}=αfₛ;
Where α is the filtering proportion coefficient;
Step 2: the high-pass filter is used to eliminate the low-frequency noise of original acceleration signal, the following recursive high-pass filter is selected:
$${y}_{i} = \frac{1 + q}{2} ( {x}_{j} - {x}_{j - 1} ) + {qy}_{j - 1} ;$$
Where xⱼ and yⱼ(j=1, 2, 3 . . . ) are the input and output signals, respectively, q is a constant parameter approximating to 1;
Step 3: Calculate the displacement of the bridge by the recursive acceleration integration method:
The recursive least-square method is first used for baseline correction, a recursive high-pass filter is used to filter the low-frequency noise in the monitoring acceleration signal, and the acceleration is then integrated to obtain the bridge displacement;
Step 4: Taking the displacement data obtained by integration as the real part and its Hilbert transform as the imaginary part, the analytic signal is given as:
x(t)=x(t)+i\hat{x}(t);
Where \hat{x}(t) is the Hilbert transform of the time-domain signal x(t):\hat{x}(t)=H(x(t)) and i is the imaginary unit;
For discrete monitoring data, the form of Hilbert transform can be expressed as:
$$\hat{x} ( t ) = {\sum }_{m = 0}^{N} h ( i - m ) x ( m ) ;$$
Where x(m) is the sampling signal;
N is the length of the sampling signal, h(i) is the discrete Hilbert transform impulse response operator, which has the closed form:
$$h ( i ) = \frac{2}{N} {sin}^{2} ( π i / 2 ) cot ( π i / N ) ;$$
The real and imaginary parts of the analytical signal in the complex domain can be calculated, and the image of the data complex plane vector is drawn with the real part as the x-axis and the imaginary part as the y-axis;
Or by directly applying the short-time recursive Hilbert transform to the real-time acceleration monitoring signal and plotting the complex plane vector image with the real part as the x-axis and the imaginary part as the y-axis;
Step 5: VIV judgement:
Vector images generated by the real and imaginary parts of the complex domain analytical signal:
If VIV occurs, the image shows circular characteristics; the image in the non-VIV region is cluttered and irregular, the image features can help achieve the real-time identification and early warning of VIV generation;
Vector images generated by the real and imaginary parts of the original acceleration signal:
If VIV occurs, the image shows approximately circular features; the image in the non-VIV region is cluttered and irregular, the image features can help achieve the real-time identification and early warning of VIV generation.

2. The method according to claim 1, wherein the bridge vibration displacement data is obtained based on the integration of the acceleration signal from Step 3, and the instantaneous frequency, phase and amplitude of the bridge during VIV can be obtained;
1) The instantaneous phase:
The real part and imaginary part of the integral displacement signal, then the instantaneous phase φₜ of VIV is given by:
$${φ}_{t} = arc tg \frac{\hat{x} ( t )}{x ( t )} ;$$
2) The instantaneous frequency:
The instantaneous frequency fₜ be calculated by calculating the first derivative of instantaneous phase with respect to time:
$${f}_{t} = \frac{d {φ}_{t}}{dt} = \frac{d}{dt} arc tg \frac{\hat{x} ( t )}{x ( t )} ;$$
3) The real-time amplitude:
The real-time amplitude A, of bridge during VIV can be obtained by calculating the modulus of the real and imaginary parts of the analytic signal in the complex field:
Aₜ=\sqrt{x(t)²+\hat{x}(t)²};
The real-time full process measurement of VIV.
